(19) United States
(12) Patent Application Publication
(10) Pub. No.: US 2002/0173968 A1
(43) Pub. Date: Nov. 21, 2002

(54) Encoded audio files having embedded printable lyrics

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/861,048

(22) Filed: May 17, 2001

(51) Int. Cl. G10L 21/00; G10L 19/00

(52) U.S. Cl. 704/500

(57) ABSTRACT

Systems and methods are described for embedding access to printable lyrics into an encoded audio file. In one implementation, a device edits an audio file to embed an indication of printable lyrics into the audio file. The indication specifies that the printable lyrics are either embedded in the audio file or stored in another file. The encoded audio file is communicated to a different device. Responsive to receiving the encoded audio file, the different device accesses the printable lyrics using the information in the audio file, and prints the accessed lyrics.

### TECHNICAL FIELD

The described subject matter relates to embedding printable lyrics into a digital audio file format such that a printing device will print the encoded lyrics upon receipt of a digital audio file.

### BACKGROUND

Audio encoding algorithms are used to digitally encode and compress music into encoded audio formats at near-CD quality. Such encoded audio formats include WINDOWS Media Audio (WMA), Motion Picture Experts Group (MPEG) Layer 3 (MP3), and other encoded audio formats. Encoded audio files can be easily transmitted over the Internet and stored in an on-line music library, a computer, a portable music player such as a Diamond RIO® player, and/or the like, for future playback.

FIG. 1 is a block diagram of a conventional MPEG audio file format 100. The format typically includes a number of compressed sound packet data frames 110 and a single additional set of data 112. The compressed sound data is the actual encoded digital audio that can be decoded by an MPEG decoder for future playback. An MPEG decoder when playing an MPEG file ignores the additional data.

The additional data 112 includes a tag 114-1 (“TAG”) at the beginning of the structure to indicate to an application that specific types of ancillary information may be available in the structure. Such ancillary information includes a title 114-2, an artist indication 114-3, an album indication 114-4, a year indication 114-5, a comment field 114-6, and a genre indication 114-7 (e.g., blues, classic rock, country, hip-hop, and the like). The size of this additional data is constrained by the MPEG format to be exactly one-hundred-and-twenty-eight (128) bytes long. Thus, each respective ancillary information item 114-1 through 114-7 has a predetermined byte-size that is located at a predetermined offset within the structure.

FIG. 2 is a block diagram 200 that shows predetermined byte sizes and offsets into an additional set of data that may be placed at the end of an MPEG audio file. (See, the additional data 112 of FIG. 1). Column 210 provides the respective byte-size for each respective value 114 of the additional data. Column 212 provides the respective offset number of bytes from the beginning of the additional data so that an application can locate a particular value within the additional data. For example, byte-size indication 210-1 and offset indication 212-1 reserve the first three (3) bytes for a tag indication 114-1 (offset of “0”). Whereas, size indication 210-2 and offset indication 212-2 reserve the next thirty (30) bytes for a title indication, and the like.

If a digital audio file includes the ancillary data structure 112 of FIG. 1, then existing systems for playing the audio file typically provide means for a user of the system to display and view the predetermined ancillary information values 114. However, these existing systems do not typically provide the user with access to a printable version of the lyrics that correspond to the audio on the digital audio file. Unfortunately, locating a printable version of lyrics that correspond to a digital audio file is typically a tedious process, especially if one must search the Internet for the lyrics and print them separately.

The subject matter described herein addresses these and other problems with obtaining a printable version of encoded digital audio lyrics.

### SUMMARY

Systems and methods are described for embedding access to printable lyrics into an encoded audio file. In one implementation, a device edits an audio file to embed an indication of printable lyrics into the audio file. The indication specifies that the printable lyrics are either embedded in the audio file or stored in another file. The encoded audio file is communicated to a different device. Responsive to receiving the encoded audio file, the different device accesses the printable lyrics using the information in the audio file, and prints the accessed lyrics.

### BRIEF DESCRIPTION OF THE DRAWINGS

The same numbers are used throughout the drawings to reference like features and components.

FIG. 1 is a block diagram that shows a conventional MPEG audio file format.

FIG. 2 is a block diagram that shows predetermined byte sizes and offsets into an additional set of data that may be placed at the end of an MPEG audio file.

FIG. 3 is a block diagram that shows aspects of an exemplary audio file format to embed printable lyrics directly into a digital audio file.

FIG. 4 is a block diagram that shows aspects of an exemplary audio file format to provide a reference to printable lyrics that are not embedded directly into an encoded digital audio file.

FIG. 5 is a block diagram that shows aspects of an exemplary system to both (a) embed access to printable lyrics into a digital audio file, and (b) to print lyrics that are accessed through the digital audio file.

FIG. 6 is a block diagram that shows aspects of an exemplary user interface (UI) to embed access to printable lyrics into an encoded audio file. Specifically, FIG. 6 illustrates a dialog box with radio buttons allowing a user to indicate a preference to either embed printable lyrics directly into the audio file, or embed a reference to a file that includes the printable lyrics into the audio file.

FIG. 7 is a block diagram that shows aspects of an exemplary UI to embed access to printable lyrics into an encoded audio file. Specifically, FIG. 7 illustrates a dialog box with a text control providing for the input of printable lyrics directly into the audio file.

FIG. 8 is a block diagram that shows aspects of an exemplary UI to embed access to printable lyrics into an encoded audio file. Specifically, FIG. 8 illustrates a dialog box with a text control providing for the input of a reference to a file that includes the printable lyrics.

FIG. 9 is a flowchart that shows an exemplary procedure to embed access to printable lyrics into a digital audio file.

FIG. 10 is a flowchart that shows an exemplary procedure to print lyrics accessed through a digital audio file.

### DETAILED DESCRIPTION

Overview

The inventive subject matter described below provides for embedding access to printable lyrics into an encoded digital audio file. The audio file is communicated to a printing device, which automatically detects, accesses, and prints the printable lyrics. Thus, a user is not required to separately locate a printable version of the lyrics corresponding to the audio file.

Exemplary Data Structures to Embed Access to Printable Lyrics

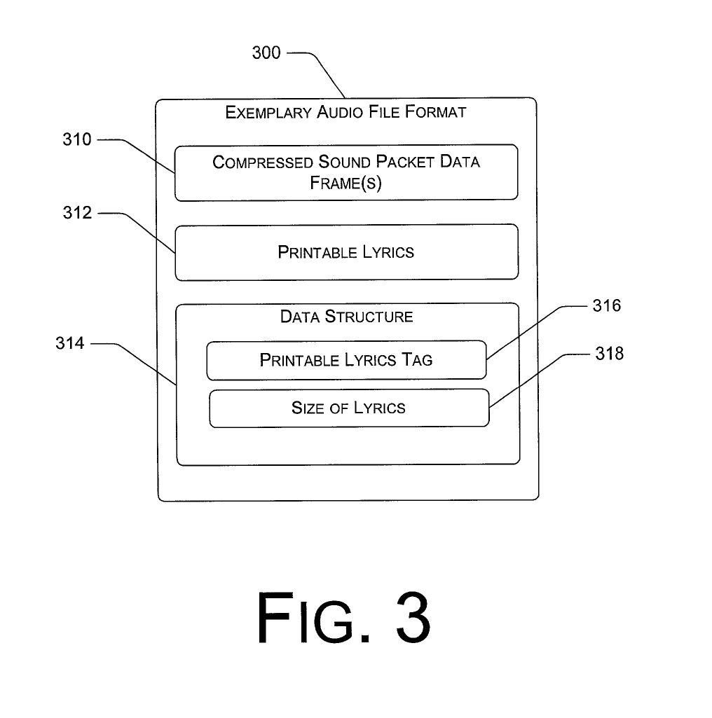

FIG. 3 is a block diagram that shows an exemplary encoded audio file format 300 to provide access to printable lyrics that correspond to an encoded digital audio file. The format includes one or more frames of encoded sound packet data 310, a block of printable lyrics 312, and a data structure 314. The compressed sound packet data is encoded digital audio data that is decoded by a digital audio player during a playback operation. The compressed sound data can be in any encoded audio format such as the MP3 format, the WMA format, and the like.

The block of printable lyrics 312 includes lyrics in a data format that is compatible with a printing device data format. Such data formats include, for example, lyrics that are in an American Standard Code for Information Interchange (ASCII) data format, lyrics in a page description format (e.g., Hewlett Packard's Printer Control Language (PCL)®, Adobe's Page Description Language (PDL)®), and the like.

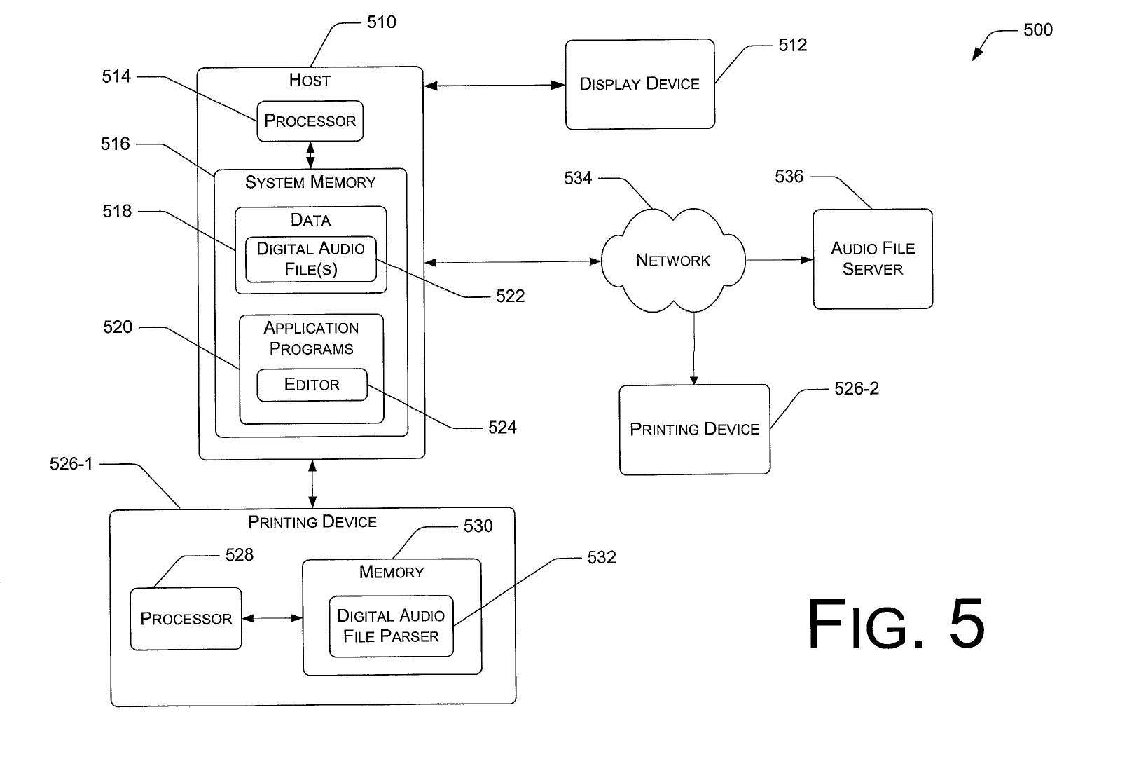

The data structure 314 includes a printable lyrics tag 316 and a size of the lyrics indication 318. The printable lyrics tag 316 indicates to a digital audio file parser application on a printing device that the encoded audio file includes an indication of where to access printable lyrics that correspond to the encoded audio file. (Aspects of an exemplary audio file parser application 526 and printing device 524 are described in greater detail below in reference to FIG. 5). The size of lyrics indication 318 indicates to the parser application (a) where to find the printable lyrics within the encoded audio file (e.g., the size of lyrics indication points out the number of bytes offset from a predetermined location in the audio file, such as the beginning or end of the data structure to locate a start of the lyrics), and (b) the number of bytes of printable lyrics in the encoded audio file that the printing device needs to print.

When a digital audio file player such as a personal computer, a handheld or laptop device, or a portable music player such as a Diamond RIO® player, is used to play an encoded audio file 300, the player decodes the compressed sound frame(s) 310 and ignores the printable lyrics block 312 and data structure 314, unless the device is suited to display such information. However, when a printing device receives the encoded audio file, the printing device ignores the sound packet data 310 and parses the data structure 314 to identify the location of and print the printable lyrics 312.

To illustrate this, consider that a conventional MP3 player will typically ignore the printable lyrics 312 and the data structure 314 if they are placed after compressed sound data 310.

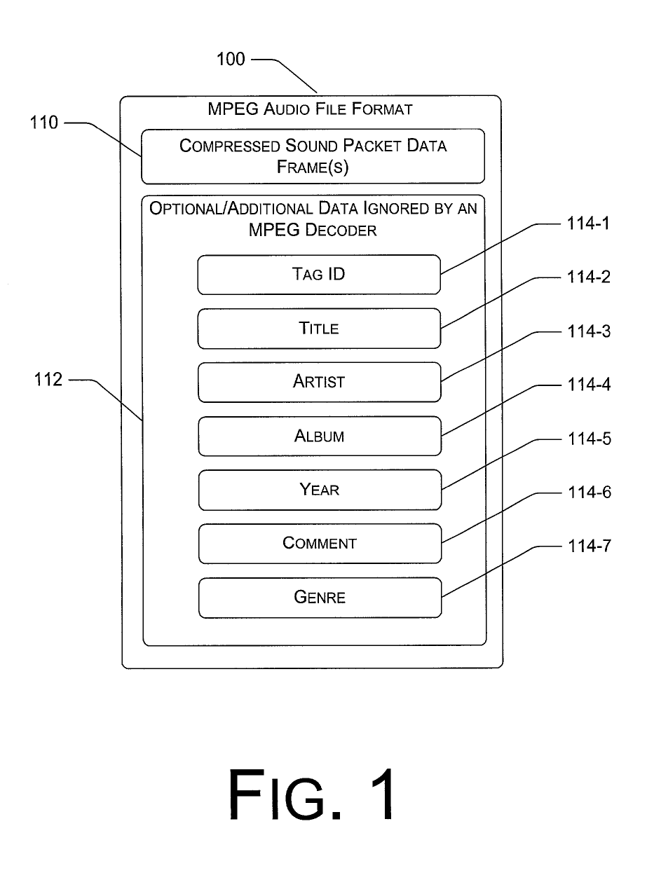

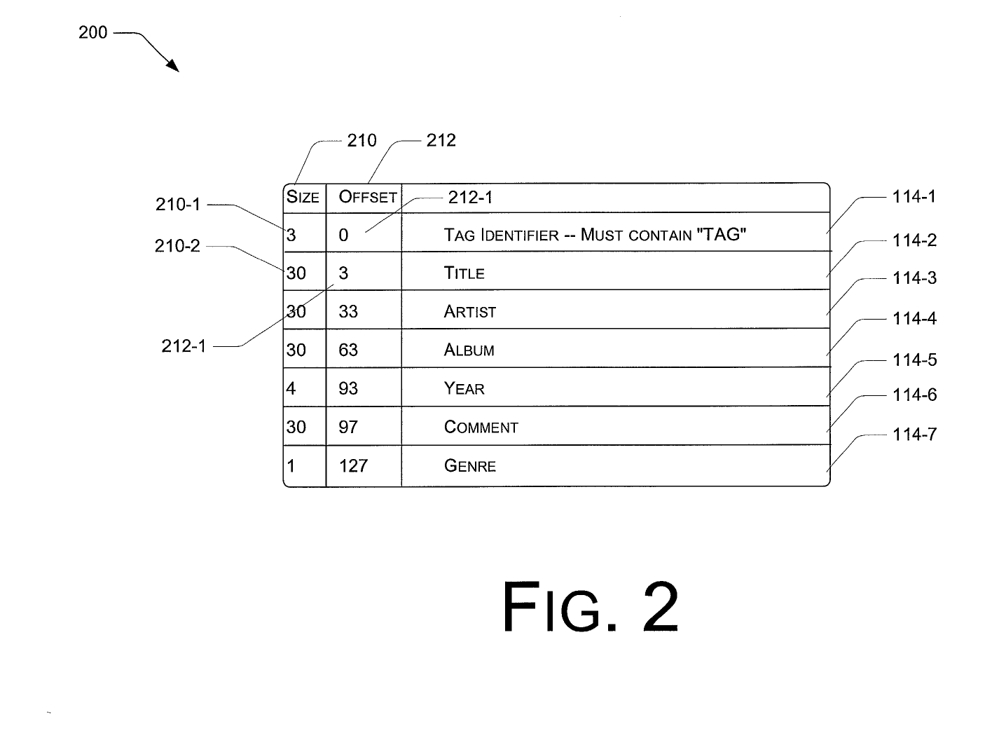

Moreover, if the data structure 314 is created to be exactly 128 bytes long and also placed at the end of the encoded audio file (as indicated in FIG. 3), the inventive aspect of the described subject matter can be implemented such that aspects of the additional data 112 of FIG. 1 can also be realized by an application used to playback audio in an encoded audio file. To illustrate this, consider that if the lyrics tag indication 316 and the size of the block of lyrics 318 indication are offset ninety-seven bytes (97) from the beginning of the data structure-and if their respective combined size is no greater than 30 bytes in length, a conventional MP3 player application can use the other 98 bytes of the data structure as described above in reference to the ancillary data structure of FIG. 1. (In this implementation, this is because the information that the printing device would access to locate the printable lyrics are stored in a portion of the data structure that is used as a comments section).

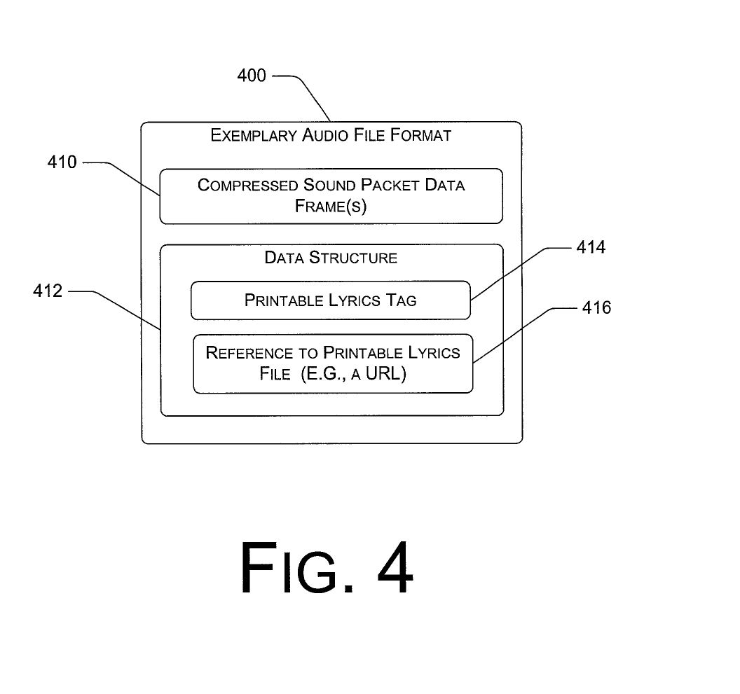

FIG. 4 is a block diagram that shows aspects of an exemplary audio file format 400 to provide a reference to printable lyrics that are not embedded directly into an encoded digital audio file. This implementation, rather than embedding the printable lyrics directly into the encoded audio file, provides a reference to printable lyrics that are stored in another location such as on a server on a network.

The encoded audio file format 400 includes one or more frames of encoded sound packet data 410 and a data structure 412. The compressed sound packet data is encoded digital audio data that is decoded by a digital audio player during a playback operation. The compressed sound data can be in any encoded audio format such as the MP3 format, the WMA format, and the like.

The data structure 412 includes a printable lyrics tag 414 and a reference to a file that includes the printable lyrics 416. The printable lyrics tag 414 indicates to a digital audio file parser application on a printing device that the encoded audio file includes an indication of where to access printable lyrics that correspond to the encoded audio file. (Aspects of an exemplary audio file parser application 526 and printing device 524 are described in greater detail below in reference to FIG. 5).

A printing device locates and accesses the printable lyrics for printing by using the reference to the printable lyrics file 416. In one implementation, the file reference is a Universal Resource Locator (URL) that identifies the printable lyrics file on another computer over the Internet. In this implementation, the printing device includes an embedded web server to access the printable lyrics file using the provided URL.

Exemplary System

FIG. 5 is a block diagram that shows an exemplary system 500 to embed access to printable lyrics into a digital audio file and to print the lyrics that are accessed through the audio file. The exemplary system is only an example of a suitable computing environment to implement the described inventive subject matter and does not suggest any limitation as to the scope of the subject matter. The system includes a computing device 510 that is coupled to a display device 512 such as a cathode ray tube (CRT) display, a liquid crystal display (LCD), and/or the like. The computing device can be any one of a number of processor based computing devices such as a personal computer, a hand-held or laptop device, and/or the like.

A computing device 510 includes a processor 514 coupled to system memory 516. The system memory includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, and/or the like.

The processor 514 is configured to fetch and/or store data from/into program data 518. Such fetched and/or stored data includes, for example, various data structures and other data such as a digital audio file 522. The digital audio file has an encoded audio file format that is based on the encoded audio file format 300 of FIG. 3 and/or the encoded audio file format 400 of FIG. 4.

The processor 514 is also configured to fetch and execute computer program instructions from program modules stored in application programs 520. Such program modules include, for example, an operating system, a user interface, and other program modules such as an encoded audio file editor 524. The audio file editor is used in combination with a user interface displayed on the display device 512 to provide access to printable lyrics by either embedding a set of printable lyrics into the audio file 522 and/or embedding a reference to a file that includes the printable lyrics into the audio file.

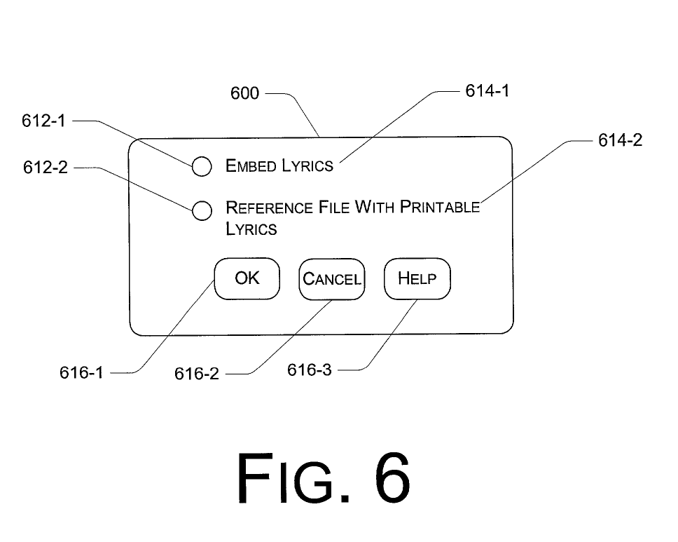

The editor 524 displays a user interface such as a dialog box onto the display 512 within which a user can enter the lyrics or a reference to a file that includes the lyrics using an input device such as a keyboard, a voice recognition system, and/or the like. (Aspects of an exemplary user interface provided by the editor are described in greater detail below in reference to FIGS. 6 through 8). The editor stores the entered lyrics into a predetermined position within the encoded audio file 522, or provides a reference to a file that includes the lyrics. The editor creates a data structure 314 of FIG. 3, or a data structure 412 of FIG. 4, which it inserts into the audio file at a predetermined location so that it can be later accessed by a printer device to locate and print the printable lyrics. In one implementation, the audio file editor also encodes raw audio such as audio from a CD-ROM into an encoded digital audio file.

The computing device 510 is operatively coupled to a printing device 526 for printing lyrics that are accessed by the printing device from information included in a digital audio file 522. The printing device may be directly coupled to the computing device such as the printing device 526-1, or the printing device may be operatively coupled to the computing device over a logical connection (e.g., over a network 530) such as the printing device 526-2.

The printing device 526 is an electronic device such as a printer, fax machine, copier, plotter, and the like. The term “printer” includes, but is not limited to, laser printers, ink jet printers, dot matrix printers, dry medium printers, copiers, facsimile machines and plotters. Although specific examples may refer to one or more of these printers, such examples are not meant to limit the scope of the claims or the description, but are meant to provide a specific understanding of the described implementations.

The printing device 526 includes a processor 528 that is coupled to a memory 530. The processor is configured to fetch and execute computer program instructions from the memory. The memory includes data and a number of program modules for data communications, for data storage, for rendering printed characters on a print medium, as well as other program modules such as a digital audio file parser module 532. The file parser module parses an encoded audio file 522 to access the printable lyrics that were associated with the file. More particularly, the parser module locates the data structure 314 of FIG. 3 or the data structure 412 of FIG. 4 within the audio file.

The computing device 510 is optionally coupled across a network 534 (e.g., the Internet, a LAN, an intranet, and/or the like) to a digital audio file server 536. In this optional implementation, the host device includes one or more application programs such as a Web browser to download encoded digital audio files from the audio file server. The downloaded digital audio files are used by the host device play a particular audio file, to embed access to printable lyrics into the downloaded file, or to print lyrics that are indicated by the audio file.

Computer-Executable Instructions

The invention is illustrated in the drawings as being implemented in a suitable computing environment. Although not required, the invention is described in the general context of computer-executable instructions, such as program modules that are executed by a computing device such as the host device 510 and/or audio file server 536. Program modules typically include routines, programs, objects, components, data structures, and the like, that perform particular tasks or implement particular abstract data types. Moreover, those skilled in the art will appreciate that the invention may be practiced with other computer system configurations, including multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices (computer-readable media).

Exemplary User Interface to Provide Access to Printable Lyrics

FIG. 6 is a block diagram that shows an exemplary UI to embed access to printable lyrics into an encoded audio file. Specifically, FIG. 6 illustrates a dialog box 600 with radio buttons 612 allowing a user to indicate a preference 612-1 to either embed printable lyrics directly into the audio file, or a preference 612-2 to embed a reference to a file that includes the printable lyrics into the audio file.

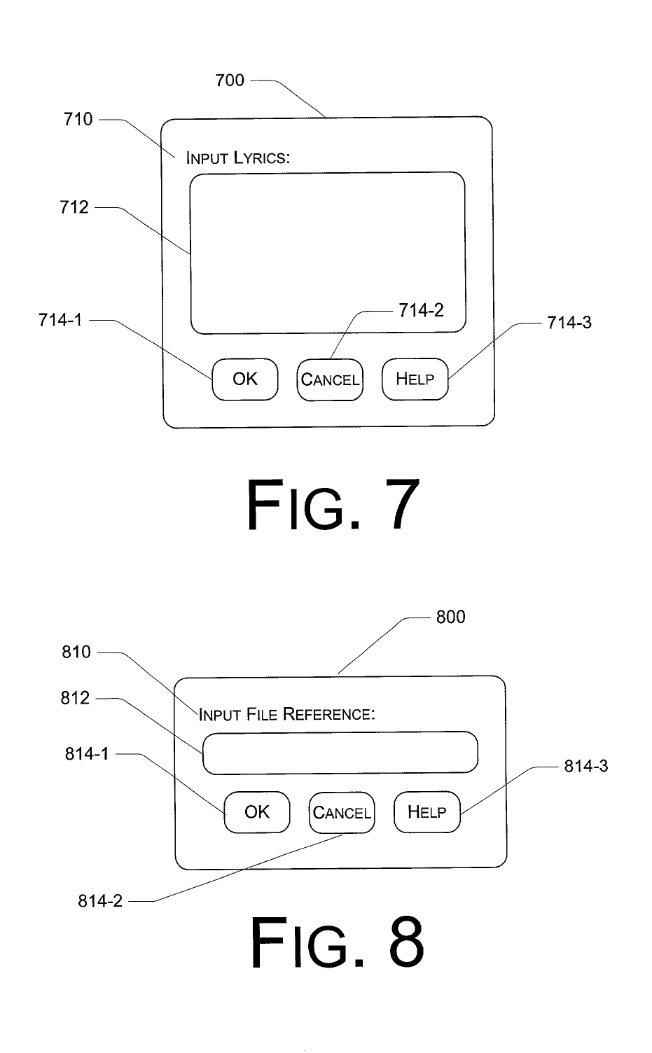

FIG. 7 is a block diagram that shows an exemplary UI to embed access to printable lyrics into an encoded audio file. Specifically, FIG. 7 illustrates a dialog box 700 with a text control 712 providing for user input of printable lyrics directly into the audio file upon selection of an “OK” button control 714-1.

FIG. 8 is a block diagram that shows an exemplary UI to embed access to printable lyrics into an encoded audio file. Specifically, FIG. 8 illustrates a dialog box 800 with a text control 812 providing for user input of a reference such as a URL and the like to a file that includes the printable lyrics.

Exemplary Procedure to Embed Access to Printable Lyrics

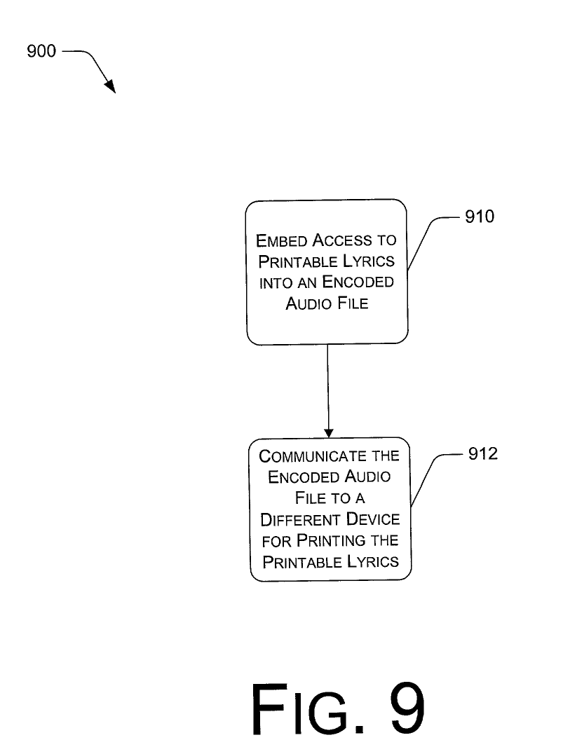

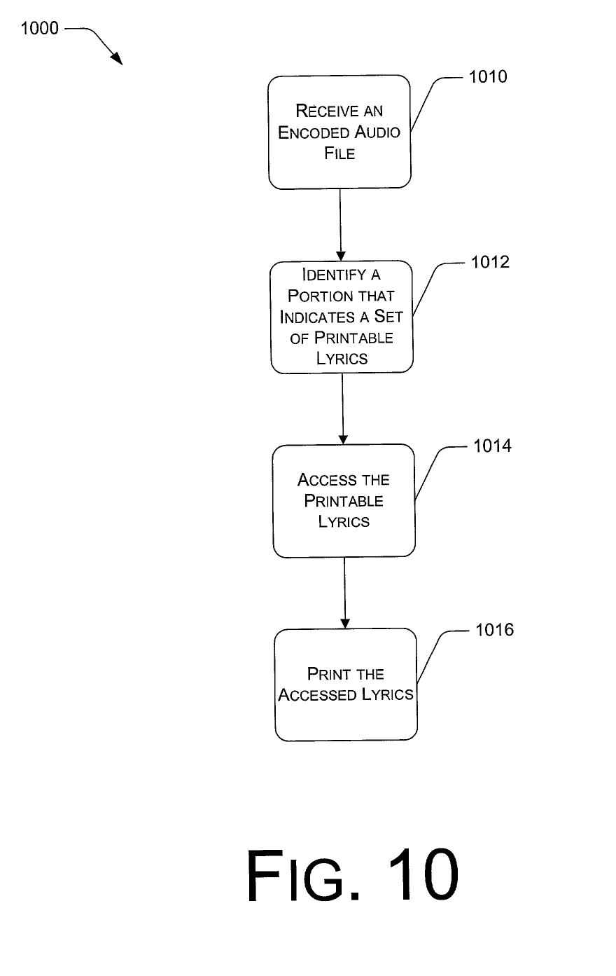

FIG. 9 is a flowchart that shows an exemplary procedure 900 to embed access to printable lyrics into a digital audio file. At block 910, the procedure embeds access to printable lyrics into an encoded audio file. This can be accomplished in a number of different ways as described above in reference to the encoded audio file editor 524 of FIG. 5 and as described above in reference to the exemplary user interfaces of FIGS. 6 through 8.

At block 912, the procedure communicates the encoded audio file to a different device such as a printing device 526 of FIG. 5 to print the printable lyrics. An exemplary procedure to print the printable lyrics accessed via an encoded audio file is described in greater detail below in reference to FIG. 10.

Exemplary Procedure to Print Lyrics

FIG. 10 is a flowchart that shows an exemplary procedure 1000 to print lyrics accessed through a digital audio file. At block 1010, the procedure receives an encoded audio file. At block 1012, the procedure identifies a portion of the encoded audio file that indicates where the printable lyrics that correspond to the audio file are stored. (Exemplary aspects of storing the printable lyrics are described in greater detail above in reference to the data structure 300 of FIG. 3 and/or the data structure 400 of FIG. 4). At block 1014, the procedure accesses the identified printable lyrics (block 1012). At block 1016, the procedure prints the accessed lyrics. If the lyrics are in a print-ready format, the printer immediately processes them. If they are in another format, such as text, the lyrics are passed to the proper format translator (in this case, text), which will translate the text to a printer-ready format which can then be processed by the printer. This translator can exist either on the printer, or remotely.

Conclusion

The described subject matter provide for embedding access to printable lyrics in encoded audio files. Although the subject matter has been described in language specific to structural features and/or methodological steps, it is to be understood that the subject matter defined in the appended claims is not necessarily limited to the specific features or steps described. Rather, the specific features and steps are disclosed as preferred forms of implementing the claimed invention.

1. A method comprising:
receiving an encoded audio file;
responsive to receiving the encoded audio file, identifying a portion of the encoded audio file that indicates a set of lyrics;
accessing the lyrics based on the portion; and
printing the lyrics.

2. A method as recited in claim 1, wherein the identifying further comprises:
locating a printable lyrics tag identifier in the encoded audio file; and
responsive to locating the printable lyrics tag identifier:
(a) determining a number of bytes of the encoded audio file that correspond to the lyrics; and
(b) determining an offset from the printable lyrics tag identifier, the offset indicating a position within the encoded audio file containing the lyrics, the lyrics having a size based on the number of bytes.

3. A method as recited in claim 1, wherein the identifying further comprises:
locating a printable lyrics tag identifier in the encoded audio file; and
responsive to locating the printable lyrics tag identifier, determining a location of a file that provides the lyrics;
wherein accessing the lyrics further comprises downloading the file from the location; and
wherein printing the lyrics further comprises printing the downloaded file.

4. A computer-readable medium comprising computer-executable instructions to perform a method as recited in claim 1.

5. A method comprising:
embedding an indication of a set of printable lyrics into an encoded audio file; and
communicating the encoded audio file to a different device, the different device being configured to cause the printable lyrics to be accessed using the indication and printed

6. A method as recited in claim 5, wherein embedding the indication of the printable lyrics further comprises:
inserting a printable lyrics tag into a data structure in the encoded audio file, the printable lyrics tag indicating to a printing device that the printable lyrics are accessed with a set of additional information in the data structure.

7. A method as recited in claim 5, wherein the encoded audio file comprises a set of compressed sound data, and wherein embedding the indication of the printable lyrics further comprises:
inserting a printable lyrics tag into a data structure, the printable lyrics tag indicating to a printing device that the printable lyrics are accessed with a set of additional information in the data structure; and
appending the data structure to the encoded audio file such that the data structure is located after the compressed sound data.

8. A method as recited in claim 5, wherein embedding the indication of the printable lyrics further comprises:
inserting a printable lyrics tag into a data structure in the encoded audio file, the printable lyrics tag indicating to a printing device that the printable lyrics are accessed with additional information in the data structure;
inserting a printable lyrics size indication into the data structure, the printable lyrics size indicating a byte size of the printable lyrics; and
inserting an offset indication into the data structure, the offset indicating a location of the printable lyrics in the encoded audio file.

9. A method as recited in claim 5, wherein embedding the indication of the printable lyrics further comprises:
inserting a printable lyrics tag into a data structure in the encoded audio file, the printable lyrics tag indicating to a printing device that the printable lyrics are accessed with a set of additional information in the data structure, the additional information comprising a Universal Resource Locater (URL) to identify the printable lyrics on a device located on a network.

10. A computer-readable medium comprising computer-executable instructions to perform a method as recited in claim 5.

11. A computer-readable medium comprising computer-executable instructions comprising instructions for:
receiving an encoded audio file;
responsive to the receiving, identifying a portion of the encoded audio file that indicates a set of lyrics;
accessing the lyrics based on the portion; and
printing the lyrics.

12. A computer-readable medium as recited in claim 11, wherein the instructions for identifying the portion further comprise instructions for:
locating a printable lyrics tag identifier in the encoded audio file; and
responsive to the locating:
(a) determining a number of bytes of the encoded audio file that correspond to the lyrics; and
(b) determining an offset from the printable lyrics tag identifier, the offset indicating a position within the encoded audio file containing the lyrics, the lyrics having a size based on the number of bytes.

13. A computer-readable medium as recited in claim 11, wherein the instructions for identifying the portion further comprise instructions for:
locating a printable lyrics tag identifier in the encoded audio file; and
responsive to the locating, determining a location of a file that provides the lyrics;
wherein the accessing further comprises downloading the file from the location; and
wherein the printing further comprises printing the downloaded file.

14. A computer comprising a processor coupled to a computer-readable memory as recited in claim 11, the processor being configured to execute the computer-executable instructions of the computer-readable memory.

15. A computer-readable medium comprising computer-executable instructions comprising instructions for:
embedding an indication of a set of printable lyrics into an encoded audio file; and
communicating the encoded audio file to a device such that the device can print the printable lyrics.

16. A computer-readable medium as recited in claim 15, wherein the instructions for embedding the indication further comprise instructions for:
inserting a printable lyrics tag into a data structure in the encoded audio file, the printable lyrics tag indicating to a printing device that the printable lyrics are accessed with a set of additional information in the data structure.

17. A computer-readable medium as recited in claim 15, wherein the encoded audio file comprises a set of compressed sound data, wherein the instructions for embedding the indication further comprise instructions for:
inserting a printable lyrics tag into a data structure, the printable lyrics tag indicating to a printing device that the printable lyrics are accessed with a set of additional information in the data structure; and
appending the data structure to the encoded audio file such that the data structure is located after the compressed sound data.

18. A computer-readable medium as recited in claim 15, wherein the instructions for embedding the indication further comprise instructions for:
inserting a printable lyrics tag into a data structure in the encoded audio file, the printable lyrics tag indicating to a printing device that the printable lyrics are accessed with additional information in the data structure;
inserting a printable lyrics size indication into the data structure, the printable lyrics size indicating a byte size of the printable lyrics; and
inserting an offset indication into the data structure, the offset indicating a location of the printable lyrics in the encoded audio file.

19. A computer-readable medium as recited in claim 15, wherein the instructions for embedding the indication further comprise instructions for:
inserting a printable lyrics tag into a data structure in the encoded audio file, the printable lyrics tag indicating to a printing device that the printable lyrics are accessed with a set of additional information in the data structure, the additional information comprising a Universal Resource Locater (URL) to identify the printable lyrics on a device located on a network.

20. A computer comprising a processor coupled to a computer-readable memory as recited in claim 15, the processor being configured to execute the computer-executable instructions of the computer-readable memory.

21. A printing device comprising:
a processor operatively coupled to a memory, the memory comprising computer-executable instructions, the processor being configured to fetch and execute the computer-executable instructions, the computer-executable instructions comprising instructions for:
receiving an encoded audio file;
responsive to the receiving, identifying a portion of the encoded audio file that indicates a set of lyrics;
accessing the lyrics based on the portion; and
printing the lyrics.

22. A printing device as recited in claim 21, wherein the instructions for identifying the portion further comprise instructions for:
locating a printable lyrics tag identifier in the encoded audio file; and
responsive to the locating:
(a) determining a number of bytes of the encoded audio file that correspond to the lyrics; and
(b) determining an offset from the printable lyrics tag identifier, the offset indicating a position within the encoded audio file containing the lyrics, the lyrics having a size based on the number of bytes.

23. A printing device as recited in claim 21, wherein the instructions for identifying further comprise instructions for:
locating a printable lyrics tag identifier in the encoded audio file; and
responsive to the locating, determining a location of a file that provides the lyrics;
wherein the accessing further comprises downloading the file from the location; and
wherein the printing further comprises printing the downloaded file.

24. A data structure for embedding access to printable lyrics into a digital audio file, the data structure comprising:
a first data field comprising encoded audio data; and
a second data field comprising a reference to a location that includes a set of printable lyrics that correspond to the encoded audio data.

25. A data structure as recited in claim 24, wherein the reference further comprises an indication of the size of the printable lyrics, and wherein the data structure further comprises:
a third data field comprising the printable lyrics.

26. A data structure as recited in claim 24, wherein the reference further comprises an indication of a file that includes the printable lyrics.

27. A data structure as recited in claim 26, wherein the indication is a Universal Resource Locator.

28. A computer-readably medium comprising a data structure as recited in claim 24.
